(19) United States
(12) Patent Application Publication
(10) Pub. No.: US 2015/0194742 A1
(43) Pub. Date: Jul. 9, 2015

(54) INSULATION DISPLACEMENT UNIT

(71) Applicant: Yazaki Corporation, Tokyo (JP)

(72) Inventor: Yasuyuki Shigezane, Susono-shi (JP)

(21) Appl. No.: 14/662,503

(22) Filed: Mar. 19, 2015

Related U.S. Application Data
(63) Continuation of application No. PCT/JP2013/075111, filed on Sep. 18, 2013.

(30) Foreign Application Priority Data
Sep. 20, 2012 (JP) 2012-206540

(51) Int. Cl. H01R 4/24

(52) U.S. Cl. CPC H01R 4/2429

(57) ABSTRACT

An object of the present invention is to simply connect an electric wire and a circuit board without using a special tool or the like. In order to achieve the above object, there is employed an insulation displacement unit which includes an electric wire supporting plate configured to support the electric wire, a base supporting plate configured to support the circuit board, and a terminal fixing plate which is disposed between the electric wire supporting plate and the base supporting plate and through which an insulation displacement connector passes. In a state where the electric wire supporting plate, the terminal fixing plate, and the base supporting plate are overlapped and bonded in a thickness direction.

### TECHNICAL FIELD

The present invention relates to an insulation displacement unit in which an electric wire and a circuit board are connected through an insulation displacement connector.

### BACKGROUND ART

Conventionally, various insulation displacement units are proposed in order to connect an insulation-coated wire to another circuit or the like through an insulation displacement connector.

For example, Patent Literature 1 discloses an insulation displacement unit (insulation displacement device) in an illuminance device for an indoor lighting system of a vehicle in which a conductive metal bus bar is disposed in an outer surface of a bottom wall of a housing for containing a lighting bulb. In order to make electric wires come into press contact with an insulation displacement connector of the bus bar, a plurality of electric wires is held in parallel in a partitioning portion on a plate portion on one side of an electric wire holder, a plate portion on the other side of the electric wire holder having a pressing through-hole portion is connected to the plate portion on one side by a hinge, both the plate portions are closed to make a rotating shaft on the hinge side of the electric wire holder be supported by a supporting portion of an electric wire holder receiving portion of the housing to be freely rotated, and the respective electric wires in the electric wire holder come into press contact with the respective insulation displacement connectors of the bus bar while rotating the electric wire holder to fall toward the bus bar, so that the electric wires are connected to a lighting bulb and the like through the bus bar.

### CITATION LIST

### Patent Literature

Patent Literature 1: JP 2012-18757 A (FIG. 4, FIG. 8)

### SUMMARY OF INVENTION

### Technical Problem

In the conventional insulation displacement unit (a first insulation displacement unit), the bus bar is assembled to the bottom wall of the housing in a state where the insulation displacement connector is formed to be erected on the bus bar, and then the electric wire in the electric wire holder comes into press contact with the insulation displacement connector of the bus bar.

Besides the above insulation displacement unit, for example, in the case of a second insulation displacement unit in which the circuit board and the electric wire are assembled to the bottom wall of the housing using a circuit board instead of the bus bar, a terminal of the connector is fixed to the circuit board by soldering or the like, the circuit board attached with a connector is assembled to the bottom wall of the housing, the terminal of the electric wire is connected to the connector, both the connectors are fitted to each other, and thus the electric wire and the circuit board are connected. In this case, the housing is not limited to the one for illuminance, but applicable to a case of an electrical connection box, for example.

However, the conventional second insulation displacement unit has a problem in that there is much trouble on connecting the terminal of the connector to the circuit board by soldering. In addition, there is a problem in that a dedicated machine, a tool, or the like is necessary for providing the connector in the terminal of the electric wire (the terminal of the connector is connected to the terminal of the electric wire) and it takes much time and cost. In addition, since the connector is provided in the circuit board, the structure becomes large.

In addition, the conventional first insulation displacement unit may cause a concern that when an operator carries with the electric wire attached with the electric wire holder in order to set the electric wire holder to the housing in a state where the electric wire is mounted in the electric wire holder, and in a case where a holding force of the electric wire asserted by the partitioning portion of the electric wire holder is weakened, the electric wire is pulled out of the electric wire holder to cause positional deviation of the electric wire with respect to the insulation displacement connector.

The invention has been made in view of the above circumstances, and an object thereof is to provide an insulation displacement unit through which the electric wire and the circuit board can be simply connected without using a special tool or the like, and the structure is simplified and the cost is reduced, and furthermore the insulation displacement unit can be around in a state where the electric wire is attached thereto.

### Solution to Problem

In order to achieve the above object, an insulation displacement unit according to one aspect of the present invention includes an electric wire supporting plate configured to support an electric wire, a base supporting plate configured to support a circuit board, and a terminal fixing plate which is disposed between the electric wire supporting plate and the base supporting plate and through which an insulation displacement connector passes. In a state where the electric wire supporting plate, the terminal fixing plate, and the base supporting plate are overlapped and bonded in a thickness direction, an insulation displacement blade on one side of the insulation displacement connector comes into press contact with the electric wire, and an insulation displacement blade on the other side of the insulation displacement connector is inserted into and connected to a through hole of the circuit board.

With the above configuration, in a state where the electric wire supporting plate on the terminal fixing plate and the base supporting plate below the terminal fixing plate are respectively overlapped, or in a state where the base supporting plate on the terminal fixing plate and the electric wire supporting plate below the terminal fixing plate are respectively overlapped, when the operator presses the electric wire supporting plate, the terminal fixing plate, and the base supporting plate in an overlapping direction using strength of hand or a press, the insulation displacement blade on one side of the insulation displacement connector fixed to the terminal fixing plate comes into press contact with and connected to the electric wire supported (held) to the electric wire supporting plate, and simultaneously the insulation displacement blade on the other side of the insulation displacement connector is inserted (press fitted) into and connected to the through hole of the circuit board supported or held to the base supporting plate. In this way, the electric wire is connected to the circuit board through the insulation displacement connector (the circuit board is connected to the electric wire through the insulation displacement connector). The electric wire is pressed and fixed to the insulation displacement blade on one side of the insulation displacement connector. It is desirable to provide a plurality of electric wires, and the number of insulation displacement connectors and the number of through holes of the circuit board are also changed according to the number of electric wires.

An insulation displacement unit according to a first preferred aspect of the present invention is the insulation displacement unit according to the one aspect of the present invention, in which the electric wire supporting plate and the base supporting plate are respectively connected to the terminal fixing plate with hinges.

With the above configuration, in a state where the electric wire supporting plate, the terminal fixing plate, and the base supporting plate are developed on a plane, for example, in a state where the electric wire is supported (held) on the upper side of the electric wire supporting plate and the circuit board is supported on the lower side of the base supporting plate, the electric wire supporting plate and the base supporting plate are rotated in the same direction about the respective hinges to be overlapped to each other with respect to the intermediate terminal fixing plate, and the electric wire supporting plate, the terminal fixing plate, and the base supporting plate are overlapped and bonded in the thickness direction. Therefore, the electric wire and the circuit board are simply and smoothly connected through the insulation displacement connector.

An insulation displacement unit according to a second preferred aspect of the present invention is the insulation displacement unit according to the one aspect or the first preferred aspect of the present invention, in which the insulation displacement blade on the other side of the insulation displacement connector is configured to include a pair of insulation displacement pieces, and the pair of insulation displacement pieces are inserted into and connected to the pair of through holes.

With the above configuration, the respective insulation displacement pieces of the insulation displacement blade on the other side of the insulation displacement connector is inserted (press fitted) into the respective through holes of the circuit board, and the pair of insulation displacement pieces reliably comes into contact with the inner surfaces of the respective through holes in a state of being pressed by an elastic force in the width direction (the alignment direction of the insulation displacement piece or the development direction of the insulation displacement piece).

An insulation displacement unit according to a third preferred aspect of the present invention is the insulation displacement unit according to any of the one aspect to the second preferred aspect of the present invention, in which the electric wire supporting plate and the base supporting plate are fixed to each other by a locking means in the bonding state.

With the above configuration, in a state where the electric wire supporting plate and the base supporting plate are respectively closed with respect to the intermediate terminal fixing plate, the electric wire supporting plate and the base supporting plate are fixed to each other by the locking means, and the connection state between the electric wire, the insulation displacement connector, and the circuit board is maintained.

### Advantageous Effects of Invention

According to the one aspect of the present invention, the electric wire supporting plate supporting the electric wire, the terminal fixing plate fixing the insulation displacement connector, and the base supporting plate supporting the circuit board are overlapped and pressed in the thickness direction, so that the electric wire and the circuit board can be simply connected through the insulation displacement connector without using a special tool. In addition, the structure of the insulation displacement unit can be simplified and the cost can be lowered by a small number of components including the electric wire supporting plate, the terminal fixing plate attached with the insulation displacement connector, and the base supporting plate. In addition, the operator can pick up the electric wire to carry with the insulation displacement unit by connecting and fixing the electric wire to the insulation displacement blade on one end side of the insulation displacement connector, and mounting workability of the insulation displacement unit onto a portion on an attaching side of a vehicle or the like can be improved.

According to the first preferred aspect of the present invention, in a state where the insulation displacement unit is developed on a plane, the electric wire and the like can be easily set, and the electric wire supporting plate and the base supporting plate are rotated about the respective hinges toward the intermediate terminal fixing plate to be overlapped and bonded in the thickness direction, so that the electric wire and the circuit board can be smoothly, simply and reliably connected through the insulation displacement connector.

According to the second preferred aspect of the present invention, the pair of insulation displacement pieces of the insulation displacement blade on the other side of the insulation displacement connector comes into elastic contact with the inner surfaces of the respective through holes of the circuit board by an elastic force in an opening and closing direction of the pair of insulation displacement pieces, so that the electrical connection between the insulation displacement connector and the circuit board can have increased reliability.

According to the third preferred aspect of the present invention, the insulation displacement unit in the closed state is locked to the closed state by the locking means, so that the electrical connection state between the electric wire, the insulation displacement connector, and the circuit board is reliably maintained, and for example the electrical connection can have increased reliability against a vibration of the vehicle, a change with time, and the like.

### BRIEF DESCRIPTION OF DRAWINGS

FIG. 1 is a perspective view of a development state illustrating an embodiment of an insulation displacement unit according to the present invention.

FIG. 2 is an exploded perspective view illustrating a connection structure between an insulation displacement connector and a circuit board in the insulation displacement unit.

FIG. 3 is an exploded perspective view illustrating main parts of FIG. 2 on a magnified scale.

FIG. 4 is a front view (portion in a circle is an enlarged view of main parts) taken the cross section of the main parts, illustrating the insulation displacement unit in a progress of assembling (connection).

FIG. 5 is a vertical cross-sectional view (portion in a circle is an enlarged view of the main parts) illustrating the insulation displacement unit after the assembling (connection) is completed.

### SOLUTION TO PROBLEM

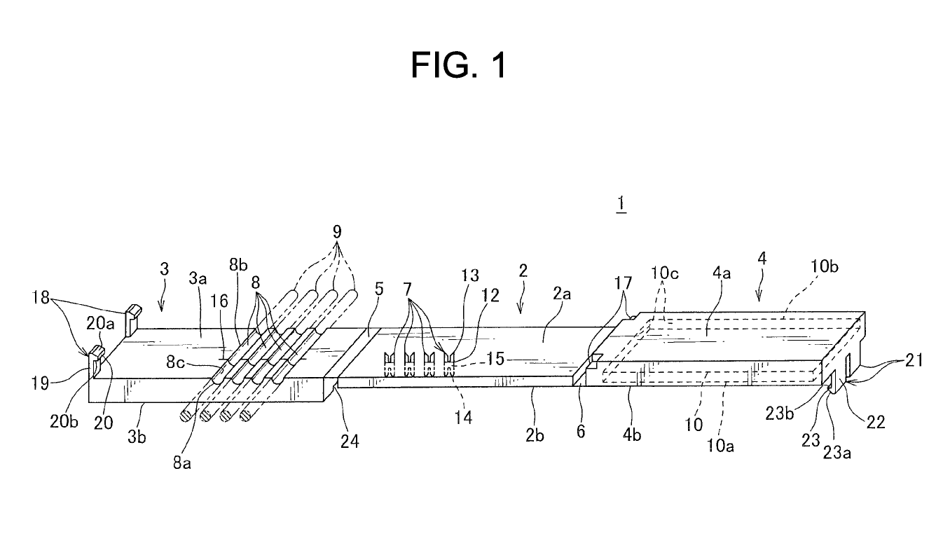

FIGS. 1 to 5 illustrate an embodiment of an insulation displacement unit according to the present invention.

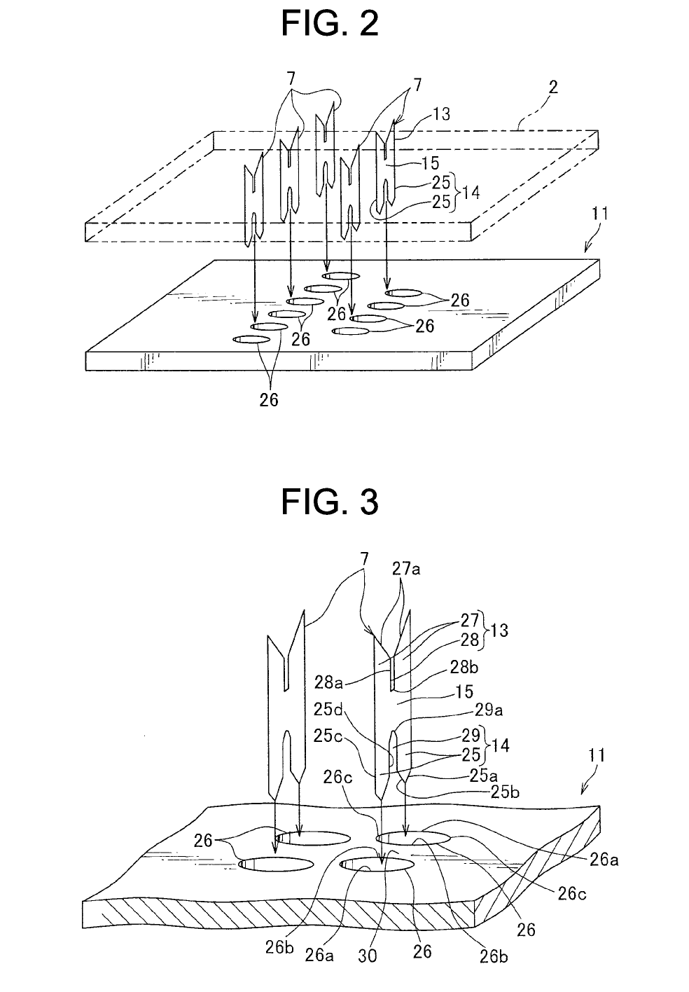

As illustrated in FIG. 1, the insulation displacement unit 1 is configured to include a rectangular terminal fixing plate 2 which is made of synthetic (insulating) resin and has a flat center portion, a rectangular electric wire supporting plate 3 which is made of synthetic (insulating) resin and integrally connected to the left end of the terminal fixing plate 2 through a thin hinge 5, a rectangular base supporting plate 4 which is made of synthetic (insulating) resin and integrally connected to the right end of the terminal fixing plate 2 through a thin hinge 6, a plurality of conductive metal insulation displacement connectors 7 which is fixed to the terminal fixing plate 2, insulation-coated wires 9 which are respectively disposed in a plurality of electric wire supporting grooves 8 of the electric wire supporting plate 3, and a circuit board 11 (FIG. 2) which is contained in a concave space 10 of the base supporting plate 4.

The terminal fixing plate 2 is formed to be thinner than the electric wire supporting plate 3 and the base supporting plate 4. The plurality of insulation displacement connectors 7 is previously provided to pass through the terminal fixing plate 2 in the thickness direction of the terminal fixing plate. The respective insulation displacement connectors 7, for example, are integrally fixed to the terminal fixing plate 2 by being molded with resin, or are press fitted into respective slit holes 12 provided in the terminal fixing plate 2. In the example of FIG. 1, four insulation displacement connectors 7 are disposed in parallel at an equal pitch in a longitudinal direction (a right and left direction) of the terminal fixing plate.

Each of the insulation displacement connectors 7 is configured to include an upper half insulation displacement blade 13 for connection to the electric wire, a lower half insulation displacement blade 14 for connection to the circuit board, and an intermediate plate portion 15 for connection of both the insulation displacement blades 13 and 14. The upper half insulation displacement blade 13 protrudes (exposure) upward from an upper surface 2a of the terminal fixing plate 2 in the vertical direction. The lower half insulation displacement blade 14 protrudes (exposure) downward from a lower surface 2b of the terminal fixing plate 2 in the vertical direction. The intermediate plate portion 15 is embedded (buried) inside the terminal fixing plate 2 in the vertical direction.

The thin hinge 5 at the left end is provided to be substantially flush with the upper surface 2a of the terminal fixing plate 2, the right end of the thin hinge 5 is connected to the left end surface (side surface) of the terminal fixing plate 2, the left end of the thin hinge 5 is connected to the right end surface (side surface) of the electric wire supporting plate 3, and an upper surface 3a of the electric wire supporting plate 3 is positioned to be substantially flush with the upper surface 2a of the terminal fixing plate 2.

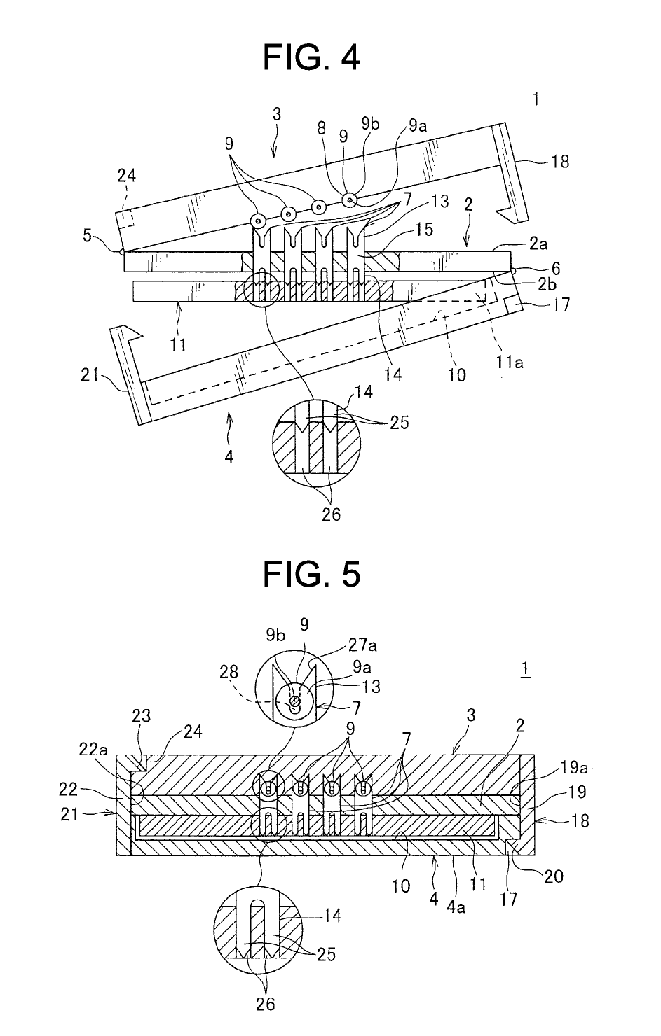

Further, in FIG. 1 illustrating a development state of the insulation displacement unit 1, the upper surface 3a of the electric wire supporting plate 3 in FIG. 1 becomes a lower surface (inner surface) of the electric wire supporting plate 3 at the time when the electric wire supporting plate 3 of FIGS. 4 and 5 is closed, and the left end of the electric wire supporting plate 3 of FIG. 1 becomes the right end at the time of when the electric wire supporting plate 3 of FIGS. 4 and 5 is closed.

The plurality (four pieces in the example of FIG. 1) of electric wire supporting grooves 8 is provided in the upper surface (the surface becoming the inner surface at the time of closing) 3a of the electric wire supporting plate 3 along a transverse direction (a front and rear direction) of the electric wire supporting plate, and the respective electric wire supporting grooves 8 are disposed in the longitudinal direction (the right and left direction) of the electric wire supporting plate at an equal pitch. Each of the electric wire supporting grooves 8 is formed in a substantially semicircular shape in cross-sectional view, desirably a long arc 8a rather than the semicircle, and may be configured to have an inner diameter at almost the same degree as the outer diameter of an electric wire 9 and an upper opening 8b which is slightly narrower than the outer diameter of the electric wire 9 in order to softly press and hold each insulation-coated wire 9.

In a peripheral surface 8c of the electric wire supporting groove 8 and the electric wire supporting plate of the upper surface (inner surface) 3a in the vicinity thereof, a slit 16 to insert the insulation displacement blade in the transverse direction of the electric wire supporting groove is provided to face the upper half insulation displacement blade 13 of each insulation displacement connector 7 in the terminal fixing plate 2 at the time when the electric wire supporting plate 3 is clockwise closed. The slit 16 is formed not to pass through the lower surface (outer surface) 3b of the electric wire supporting plate 3.

In the end portion (left end) on the side opposite to the hinge 5 at the right end of the electric wire supporting plate 3, a pair of front and back locking arms (locking portion or locking means) 18 is provided to protrude upward to lock front and back rectangular notched grooves (engaging portions) 17 of the end portion (the end portion becoming the right side when the base supporting plate 4 is clockwise closed) of the base supporting plate 4. Each locking arm 18 is configured to include a claw portion 20 which protrudes inward (facing right) at the tip of a flexible protruding piece 19, and the claw portion 20 includes an inclined surface 20a on the upper side and a flat locking surface 20b on the lower side. Further, directional expressions such as “front”, “back”, “right”, and “left” herein are denoted for the convenience of explanation.

The left end of the other thin hinge 6 is connected to the lower surface at the right end of the terminal fixing plate 2, the lower surface at the left end of the base supporting plate 4 is connected to the right end of the thin hinge 6, and the lower surface 2b of the terminal fixing plate 2 and a lower surface (a surface becoming the inner surface when the base supporting plate 4 is closed) 4b of the base supporting plate 4 are positioned to be flush with each other. An upper surface (a surface becoming the outer surface when the base supporting plate 4 is closed) 4a of the base supporting plate is positioned higher than the upper surface 2a of the terminal fixing plate 2.

The base supporting plate 4 includes a base containing concave (supporting concave) 10 which is a rectangular concave space formed in the lower surface 4b, and the base containing concave 10 includes a lower opening 10a which is slightly narrower than the lower surface 4b of the base supporting plate 4, a bottom surface 10b which is slightly shallower than the thickness of the base supporting plate 4, and side surfaces 10c on front, rear, right and left sides. The base containing concave 10 is formed slightly wider than the circuit board 11 (FIG. 2) on front, rear, right and left sides, and is desirably formed to smoothly insert (contain) the circuit board 11 in the thickness direction of the plate.

In the end portion (right end) on the side opposite to the hinge 6 at the left end of the base supporting plate 4, a pair of front and back locking arms (locking portion or locking means) 21 is provided to protrude downward. Each locking arm 21 includes a claw portion 23 which protrudes inward (facing left) at the tip (lower end) of a flexible protruding piece 22, and the claw portion 23 includes an inclined surface 23a on the lower side and a flat locking surface 23b on the upper side.

A pair of locking arms 21 of the base supporting plate 4 of the example is disposed closer each other in the front and rear direction compared to a pair of locking arms 18 of the electric wire supporting plate 3, and a pair of front and back notched grooves (engaging portions) 24 is provided in the right side surface of the electric wire supporting plate 3 to be engaged with the claw portions 23 of the respective locking arms 21. Further, while the respective notched grooves 17 and 24 are excluded, outer surfaces 3b and 4a of the end portions of the respective supporting plates 3 and 4 may be used as the engaging portions (in this case, since the claw portions 20 and 23 of the locking arms 18 and 21 protrude to the outside and thus will cause hindrance or interference). The shapes, numbers, and positions of the respective locking portions 18 and 21 and the respective engaging portions 17 and 24 may be appropriately set.

As illustrated in FIG. 2, through holes 26 of an elliptical slit shape are provided for inserting (press fitting) into a pair of right and left insulation displacement pieces 25 included in the insulation displacement blade 14 facing downward for the connection to the substrate of the respective insulation displacement connectors 7 previously fixed to the terminal fixing plate 2. The through holes 26 pass through the circuit board 11 to be contained in the base containing concave 10 of the base supporting plate 4 (FIG. 1) in the upward and downward direction (the thickness direction of the circuit board). In FIG. 2, the width direction of the respective insulation displacement connectors 7 is the right and left direction of FIG. 1, that is, the alignment direction of the respective electric wires 9, and the thickness direction the respective insulation displacement connectors 7 is the front and rear direction of FIG. 1, that is, the longitudinal (axial) direction of the respective electric wires 9. The respective insulation displacement connectors 7 are fixed to the terminal fixing plate 2 at the center of the plate portion 15 in the longitudinal direction.

The peripheral surface in each through hole 26 is desirably subjected to conductive plating. A conductive plating layer in the through hole 26, for example, is electrically connected to a printed circuit (circuit) (not illustrated) in the lower surface of the circuit board 11 of FIG. 2, a conductive metal plate (core) at the center of the circuit board 11 in the thickness direction, and the like. In the example of FIG. 2, the description is made about an example in which five insulation displacement connectors 7 are used. Two insulation displacement connectors 7 on the front side and three insulation displacement connectors 7 on the rear side are disposed alternately (in a staggered shape) at a narrow pitch, and the respective electric wires 9 in the five electric wire supporting grooves 8 arranged on the right and left of the electric wire supporting plate 3 (FIG. 1) come into press contact with the upward insulation displacement blade 13 of each insulation displacement connector 7.

As illustrated in FIG. 3, the upper half insulation displacement blade 13 of each insulation displacement connector 7 is configured by a pair of right and left insulation displacement pieces 27 and a narrow slit 28 in the vertical direction therebetween, the pair of insulation displacement pieces 27 includes V-shaped blade portions 27a on the upper side, an insulative cover 9a (FIG. 4) of the insulation-coated wire 9 (FIG. 1) is cut by the blade portion 27a, and the inner surface (inner end) 28a of the slit 28 is in tight contact with a core wire (conductor) 9b (FIG. 4) of the insulation-coated wire 9. A lower end 28b of the slit 28 prevents the electric wire 9 from farther moving to the downward direction. The upper half insulation displacement blade 13 has the same structure as that of an existing insulation displacement connector. The base fixing plate 2 is not illustrated in FIG. 3.

The lower half insulation displacement blade 14 of the insulation displacement connector 7 is different from the upper half insulation displacement blade 13, and is configured by the pair of right and left insulation displacement pieces 25 and a wide slit 29 in the vertical direction therebetween. The tip portion (lower end portion) of each insulation displacement piece 25 is sharply formed in a substantially V shape having an outward inclined blade 25a and an inward inclined blade 25b.

The pair of right and left through holes 26 of the circuit board 11 corresponding to the lower half insulation displacement blade 14, for example, is separated on the right and left at a pitch slightly larger than that of the pair of right and left insulation displacement pieces 25 of the insulation displacement blade 14, and the right and left insulation displacement pieces 25 are slightly press fitted and inserted into the right and left through holes 26 while being slightly separated. At this time, the inward inclined blade 25b of each insulation displacement piece 25 comes into sliding contact with an inner end 26b on the short-diameter side of each elliptic through hole 26, and the outer inclined blade 25a comes into sliding contact with an outer end 26a on the short-diameter side of the subject through hole 26, so that the insertion (press fit) of the insulation displacement piece 25 into the through hole 26 is smoothly and reliably performed.

Each through hole 26 is formed in an elliptic shape, long diameter portions 26c of the through hole 26 are matched with the thickness direction (the front and rear direction) of the insulation displacement connector 7, and short diameter portions 26a and 26b of the through hole 26 is matched with the width direction (the right and left direction) of the insulation displacement connector 7. In a state where each insulation displacement piece 25 is elastically separated slightly outward, an outer end 25c of each insulation displacement piece 25 comes in strong contact with the conductive plating layer of the inner surface (26a) on the short-diameter side of each through hole 26 (an inner end 25d of each insulation displacement piece 25 comes into contact with the conductive plating layer of the inner surface (26b) on the short-diameter side of each through hole 26), so that a circuit (not illustrated) of the circuit board 11 and the insulation displacement connector 7 are electrically connected.

The pair of insulation displacement pieces 25 which are inserted into the respective through holes 26 and separated outward elastically nip a partition wall 30 between the respective through holes 26 of the circuit board 11 by a restoring force applied inward. By the nipping force and frictional resistance between the outer end 25c in particular of the insulation displacement piece 25 and the inner surface 26a of the through hole 26, the lower half insulation displacement blade 14 is fixed to the respective through holes 26, and the insulation displacement connector 7 is prevented from being upwardly slipped out. A lower end 29a of the slit 29 of the lower half insulation displacement blade 14 comes into contact with the upper surface of the partition wall 30 between the right and left through holes 26 of the circuit board 11, and prevents the insulation displacement connector 7 from being farther pushed downward.

Further, the pitch of the pair of right and left through holes 26 is set to be equal to the pitch of the pair of right and left insulation displacement pieces 25 of the lower half insulation displacement blade 14, the short diameter of each through hole 26 is set to be equal to or smaller than the width of each insulation displacement piece 25, and each insulation displacement piece 25 is press fitted into each through hole 26, so that the outer end surface 25c and the inner end surface 25d in the width direction of the insulation displacement piece 25 each can be in press contact with the inner surfaces (26a, 26b) facing each other on the short-diameter side of the through hole 26.

In addition, the pitch of the pair of right and left through holes 26 is set to be smaller than the pitch of the pair of right and left insulation displacement pieces 25 of the lower half insulation displacement blade 14, and the short diameter of each through hole 26 is set to be equal to or larger than the width of each insulation displacement piece 25. The pair of insulation displacement pieces 25 is press fitted into the respective through holes 26 while being compressed in the width direction (a closing direction), so that the outer end surface 25c in the width direction of the insulation displacement piece 25 can be made in strong contact with the inner surface (26a) on the short-diameter side of the through hole 26 in an elastic manner (by an elastic force to separate the pair of insulation displacement pieces 25).

In addition, the through holes 26 are configured by one large through hole not by a pair of holes (in this case, the shape of the through hole 26 may be an ellipse or a circle), and the pair of insulation displacement pieces 25 is press fitted into one through hole 26 in the width direction (the closing direction) while being compressed, so that the outer end surfaces 25c in the width direction of the respective insulation displacement piece 25 may be configured to be in strong contact with the inner surfaces (26a, 26b) on the short-diameter side of one through hole 26 (by an elastic force to separate the pair of insulation displacement pieces 25).

Similarly to FIGS. 4 and 5, by closing the insulation displacement unit 1 from the development state of the insulation displacement unit 1 of FIG. 1, the upper half insulation displacement blade 13 of the respective insulation displacement connectors 7, which is fixed to the plate portion 15 at the center of the terminal fixing plate 2, comes into press contact with the respective electric wires 9 held in the respective electric wire supporting grooves 8 of the electric wire supporting plate 3. Simultaneously, the pair of insulation displacement pieces 25 of the lower half insulation displacement blade 14 of the respective insulation displacement connectors 7 is connected to the pair of through holes 26 of the circuit board 11.

In the example of FIG. 4, in the development state of the insulation displacement unit 1 of FIG. 1, the respective electric wires 9 are press fitted or pushed into the respective electric wire supporting grooves 8 of the electric wire supporting plate 3 and held therein (temporary fixing), and the tip portions of the respective insulation displacement pieces 25 of the lower half insulation displacement blade 14 of the respective insulation displacement connectors 7 previously fixed to the terminal fixing plate 2 are initially press fitted into the upper end portions of the respective through holes 26 of the circuit board 11 to be temporarily fixed.

Next, the electric wire supporting plate 3 is clockwise rotated in the closing direction about the hinge 5. The electric wire supporting plate 3 and the base supporting plate 4 are separated upward and downward in almost parallel, at the stage in which the insulation displacement unit 1 has not been completely closed as illustrated in FIG. 4. The circuit board 11 is disposed to face the lower side of the terminal fixing plate 2 inclined right down relatively (in a case where the respective supporting plates 3 and 4 are horizontally positioned) so as to approach in parallel between the hinge 5 at the left end of the electric wire supporting plate 3 on the upper side and the hinge 6 at the right end of the base supporting plate 4 on the lower side. A right end portion 11a of the circuit board 11 is contained in and supported by the right end portion of the base supporting concave 10 of the base supporting plate 4.

From this state, the base supporting plate 4 is rotated in the closing direction (clockwise) about the hinge 6 at the right end at the same time when the electric wire supporting plate 3 is rotated in the closing direction (clockwise) about the hinge 5 at the left end. The circuit board 11 is interposed up and down by the lower surface 2b of the terminal fixing plate 2 and the bottom surface of the base supporting concave 10 of the base supporting plate 4 while the electric wire 9 sequentially come into press contact with the upper half insulation displacement blades 13 of the respective insulation displacement connectors 7 fixed to the terminal fixing plate 2 from the left side (while being regularly fixed). The respective insulation displacement pieces 25 of the lower half insulation displacement blades 14 of the respective insulation displacement connectors 7 are simultaneously press fitted into the respective through holes 26 of the circuit board 11 and connected and regularly fixed thereto.

Therefore, as illustrated in FIG. 5, in the state where the insulation displacement unit 1 is completely closed, the electric wires 9 are connected to the upper half insulation displacement blades 13 of the respective insulation displacement connectors 7, and simultaneously the circuit (not illustrated) of the circuit board 11 is connected to the respective insulation displacement pieces 25 of the lower half insulation displacement blade 14 of the respective insulation displacement connectors 7 through the respective through holes 26. The respective electric wires 9 and each circuit of the circuit board 11 are electrically connected through the insulation displacement connector 7.

The claw portion 20 at the lower end of the downward locking arm 18 at the right end of the electric wire supporting plate 3 is engaged with the notched groove 17 on the right lower end side of the base supporting plate 4. Simultaneously, the claw portion 23 at the upper end of the upward locking arm 21 at the left end of the base supporting plate 4 is engaged with the notched groove 24 on the left upper end side of the electric wire supporting plate 3. Consequently, the insulation displacement unit 1 is kept in the closed (locked) state.

In process of coming the electric wire 9 and the circuit board 11 in FIGS. 4 and 5 into press contact with the insulation displacement connector 7, inner surfaces 22a of the protruding pieces 22 of a pair of front and back erected locking arms 21 at the left end of the base supporting plate 4 is in contact with the left end surface (one side surface) of the terminal fixing plate 2 and the left end surface (one side surface) of the electric wire supporting plate 3 and these left end surfaces are positioned. Simultaneously, an inner surface 19a of the protruding piece 19 of a pair of locking arms 18 immediately after being hanged down at the right end of the electric wire supporting plate 3 is in contact with the right end surface (the other side surface) of the terminal fixing plate 2 and the right end surface (the other side surface) of the base supporting plate 4 and these right end surfaces are positioned. The electric wire supporting plate 3, the terminal fixing plate 2, and the base supporting plate 4 are interposed by the respective pairs of right and left locking arms 18 and 21 and positioned in the right and left direction (the electric wire the alignment direction). Thereby, the electric wire 9 and the insulation displacement blade 13 on one side of the insulation displacement connector 7 and the insulation displacement blade 14 on the other side of the insulation displacement connector 7 and the through hole 26 of the circuit board 11 are accurately positioned. Therefore, the electric wire 9, the insulation displacement connector 7, and the through hole 26 of the circuit board 11 are smoothly and reliably connected.

As illustrated in the enlarged view of FIG. 5, the insulative cover 9a of each electric wire 9 is cut by the blade portion 27a on the upper side of the upper half insulation displacement blade 13 of each insulation displacement connector 7, and a conductive portion 9b of each electric wire 9 is elastically nipped and connected to the inner end surface of the slit 28 of the insulation displacement blade 13. In addition, the pair of insulation displacement pieces 25 of the lower half insulation displacement blade 14 of each insulation displacement connector 7 is inserted (press fitted) into the respective through holes 26 of the circuit board 11 so as to be in electrical contact with the conductive plating layer of the inner surface of the through hole 26.

The tip (lower end) of each insulation displacement piece 25 does not pass through the through hole 26 but is positioned slightly on the upper side of the bottom surface of the base supporting concave 10 of the base supporting plate 4. In a case where the length of each insulation displacement piece 25 is set to be longer than the depth of the through hole 26, a concave portion for inserting the insulation displacement piece is formed in the bottom surface of the base supporting concave 10 of the base supporting plate 4. The concave portion for inserting the insulation displacement piece is set not to pass through the outer surface (the lower surface) 4a of the base supporting plate 4.

Note that, in order to increase connection strength between the respective insulation displacement pieces 25 of the lower half insulation displacement blade 14 of the insulation displacement connector 7 and the conductive plating layer in each through hole 26 of the circuit board 11, the insulation displacement piece 25 and the conductive plating layer in the through hole 26 may be soldered. In addition, without forming the conductive plating layer in the through hole 26, the respective insulation displacement pieces 25 may be soldered (connected) to the conductive metal plate (core layer) exposed in the through hole 26. In addition, the respective insulation displacement pieces 25 may be formed long like an existing pin-shaped terminal and configured to pass through the through hole 26 to be soldered to the printed circuit and the like on the lower surface side of the circuit board 11 (in this case, insertion holes for the insulation displacement pieces are formed on the upper surface side of the base supporting plate 4).

In a state where the insulation displacement unit 1 of FIG. 5 is in closed, the connection portions between the respective electric wires 9 and the upper half insulation displacement blades 13 of the respective insulation displacement connectors 7 are covered by the electric wire supporting plate 3 on the upper side, and thus are stably protected against interference or water drops from the outside. At the same time, the circuit board 11 and the connection portions between the lower half insulation displacement blades 14 of the respective insulation displacement connectors 7 and the through holes 26 of the circuit board 11 are covered by the base supporting plate 4 on the lower side, and thus the impact on the circuit board 11 is alleviated and the connection portions between the insulation displacement blades 14 and the through holes 26 are also stably protected against interference or water drops from the outside. In FIG. 5, a housing of the insulation displacement unit 1 is configured by at least the electric wire supporting plate 3 on the upper side and the base supporting plate 4 on the lower side. The insulation displacement unit 1 is also called a press contact connector (E connector).

In addition, since the respective electric wires 9 come into press contact with the upper half insulation displacement blades 13 of the respective insulation displacement connectors 7 previously fixed to the terminal fixing plate 2 so as to be regularly fixed, the respective electric wires 9 are not displaced in the longitudinal direction even when an operator picks up the respective electric wires 9 by hand and carries with the insulation displacement unit 1. For example, even in a case where the insulation displacement unit 1 is applied to an indoor lighting system of a vehicle, the operator can assemble the insulation displacement unit 1 with the electric wire 9 in a required place in the vehicle with a good workability.

Further, in the above example of FIG. 4, as a first assembly method (structure), the portion other than the right end portion 11a of the circuit board 11 protrudes to the outside from the base supporting plate 4 and, in this state, is temporarily connected to the lower half insulation displacement blades 14 of the respective insulation displacement connectors 7 in the terminal fixing plate 2. Then, the insulation displacement unit 1 is closed to completely connect the respective electric wires 9, the respective insulation displacement connectors 7, and the respective through holes 26 of the circuit board 11. As a second assembly method (structure), an alternative assembly method may be applied. In other words, in FIG. 4, the circuit board 11 is previously contained in the base supporting concave 10 of the base supporting plate 4 without the temporary connection to the lower half insulation displacement blade 14. The electric wire supporting plate 3 which is separated upward and the terminal fixing plate 2 which is relatively inclined are closed toward the base supporting plate 4 and overlapped to each other. Therefore, the respective electric wires 9 held in the respective electric wire supporting grooves 8 of the electric wire supporting plate 3 and the respective upper half insulation displacement blades 13 of the respective insulation displacement connectors 7 fixed to the terminal fixing plate 2 are connected to be regularly fixed. Simultaneously, the respective insulation displacement pieces 25 of the respective lower half insulation displacement blades 14 of the respective insulation displacement connectors 7 of the terminal fixing plate 2 are inserted (press fitted) into and connected to the respective through holes 26 of the circuit board 11 which is supported (held) to the base supporting plate 4. The insulation displacement unit 1 enters a completely-closed lock state as illustrated in FIG. 5.

As illustrated in FIG. 3, since each through hole 26 of the circuit board 11 is formed in an ellipse or a long circle and the almost V-shaped tip portion (the outside inclined blade 25a and the inside inclined blade 25b) of each insulation displacement piece 25 of the lower half insulation displacement blade 14 of each insulation displacement connector 7 comes into sliding contact and is inserted while being guided to opening ends 26a and 26b of a short diameter portion of each through hole 26, each insulation displacement piece 25 of the lower half insulation displacement blade 14 of each insulation displacement connector 7 can be smoothly and reliably inserted (press fitted) into and connected without positional deviation in each through hole 26 of the circuit board 11 even using the second assembly method. In the second assembly method (structure), the insulation displacement unit 1 can be assembled and connected with a higher workability and efficiency compared to the first assembly method (structure).

In addition, in the description of the above embodiment, the intermediate terminal fixing plate 2, the electric wire supporting plate 3 on the upper side, and the base supporting plate 4 on the lower side are connected by the respective thin hinges 5 and 6. However, horizontal rod-shaped hinge shafts (not illustrated) are employed as the hinge instead of the thin hinges 5 and 6, and thus the terminal fixing plate 2, the electric wire supporting plate 3, and the base supporting plate 4 may be connected to be freely rotated about the respective hinge shafts. In this case, since the hinge shaft has a higher rigidity compared to the flexible thin hinges 5 and 6, the hinge shaft is not suitable for absorbing positional deviation of the electric wires 9 in the electric wire supporting plate 3 and the through holes 26 of the circuit board 11 in the base supporting plate 4 with respect to the respective insulation displacement connectors 7 of the center terminal fixing plate 2.

In addition, in the above embodiment, the electric wire supporting plate 3 is disposed on the upper side of the terminal fixing plate 2 and the base supporting plate 4 is disposed on the lower side in the assembly state of FIG. 5, respectively. In contrary, the base supporting plate 4 may be disposed on the upper side of the terminal fixing plate 2 and the electric wire supporting plate 3 may be disposed on the lower side, respectively. Accordingly, the direction of the insulation displacement connector 7 to be fixed to the terminal fixing plate 2 is set to be upside down, and the insulation displacement blade 14 for the connection to the substrate may be disposed on the upper half of the insulation displacement connector 7, and the insulation displacement blade 13 for the connection to the electric wire may be disposed on the lower half thereof.

In addition, in the description of the above embodiment, the intermediate terminal fixing plate 2, the electric wire supporting plate 3, the base supporting plate 4 on the lower side are connected by the respective hinges 5 and 6 and integrally formed by a synthetic (insulating) resin. Alternatively, the terminal fixing plate 2, the electric wire supporting plate 3, and the base supporting plate 4 may be separately formed as independent bodies by excluding the respective hinges 5 and 6. For example, the electric wire supporting plate 3 on the upper side of the intermediate terminal fixing plate 2 and the base supporting plate 4 on the lower side are configured to be overlapped to each other, and pressed in the vertical direction by a press, so that the respective electric wires 9 in the electric wire supporting plate 3 and the respective through holes 26 of the circuit board 11 in the base supporting plate 4 are connected to the respective upper and lower insulation displacement blades 13 and 14 of the respective insulation displacement connectors 7 in the terminal fixing plate 2.

However, in this case, the positioning (alignment) of the upper and lower insulation displacement blades 13 and 14 of the respective insulation displacement connector 7, the respective electric wires 9, and the respective through holes 26 of the circuit board 11 is more troublesome compared to the above embodiment, and thus workability in the connection and the assembly is degraded. Using the respective hinges 5 and 6, the electric wire supporting plates 3 and the base supporting plate 4 on the upper and lower sides are folded from the respective hinges 5 and 6 to be overlapped with the intermediate terminal fixing plate 2. For example, in a case where the electric wire 9 has a minute diameter, the connection can be simply and reliably made only by strength of operator's hand without aligning the respective electric wires 9 and the respective through holes 26 of the circuit board 11 on both sides of the respective insulation displacement connectors 7.

According to the insulation displacement unit 1 of the above embodiment, without using a special tool or an assembly apparatus, the circuit board 11 and the respective electric wires 9 are housed (in a state of being protected by the electric wire supporting plate 3 and the base supporting plate 4) and can be connected to each other through the insulation displacement connectors 7 simply and at a low cost. In addition, since the components of the insulation displacement unit 1 are simply configured by small housing members, that is, the electric wire supporting plate 3, the terminal fixing plate 2, the base supporting plate 4, and the insulation displacement connector 7, the insulation displacement unit 1 can be miniaturized, and costs for materials and assembling, and the number of assembly processes of the insulation displacement unit 1 can be reduced. In addition, since the insulation displacement unit 1 in a state of being attached to the electric wire 9 can be carried around, it is possible to improve mounting workability onto a mounting portion in the vehicle or the like.

In addition, since the structure of the insulation displacement unit 1 is simple (plain), the strength (rigidity) of the insulation displacement unit 1 is easily increased. In addition, functions of illumination and heating are easily added through, for example, applying the insulation displacement unit 1 as a part of an illumination device of the vehicle, or integrally forming heat radiating fins in a synthetic resin housing (the electric wire supporting plate 3 and the base supporting plate 4) of the insulation displacement unit 1.

The configuration described in the above embodiment is effectively applied to an assembling (connecting) method of the insulation displacement unit 1 and a connecting method of the electric wire 9 and the circuit board 11 beside the insulation displacement unit 1.

### INDUSTRIAL APPLICABILITY

An insulation displacement unit according to the invention allows an electric wire to be simply connected to a circuit board without using a special tool. The structure is simplified and a required cost is lowered. Furthermore, the insulation displacement unit can be used to be carried around in a state where the electric wire is mounted.

### REFERENCE SIGNS LIST

1: Insulation displacement unit

2: Terminal fixing plate

3: Electric wire supporting plate

4: Base supporting plate

5, 6: Hinge

7: Insulation displacement connector

9: Electric wire

11: Circuit board

13, 14: Insulation displacement blade

18, 21: Locking arm (locking means)

25: Insulation displacement piece

26: Through hole

1. An insulation displacement unit comprising:
an electric wire supporting plate configured to support an electric wire;
a base supporting plate configured to support a circuit board; and
a terminal fixing plate which is disposed between the electric wire supporting plate and the base supporting plate and through which an insulation displacement connector passes, wherein
in a state where the electric wire supporting plate, the terminal fixing plate, and the base supporting plate are overlapped and bonded in a thickness direction, an insulation displacement blade on one side of the insulation displacement connector comes into press contact with the electric wire, and an insulation displacement blade on the other side of the insulation displacement connector is inserted into and connected to a through hole of the circuit board.

2. The insulation displacement unit according to claim 1, wherein the electric wire supporting plate and the base supporting plate are respectively connected to the terminal fixing plate with hinges.

3. The insulation displacement unit according to claim 1, wherein
the insulation displacement blade on the other side of the insulation displacement connector is configured to include a pair of insulation displacement pieces, and
the pair of insulation displacement pieces is inserted into and connected to the pair of through holes.

4. The insulation displacement unit according to claim 2, wherein
the insulation displacement blade on the other side of the insulation displacement connector is configured to include a pair of insulation displacement pieces, and
the pair of insulation displacement pieces is inserted into and connected to the pair of through holes.

5. The insulation displacement unit according to claim 1, wherein the electric wire supporting plate and the base supporting plate are fixed to each other by a locking means in the bonding state.

6. The insulation displacement unit according to claim 2, wherein the electric wire supporting plate and the base supporting plate are fixed to each other by a locking means in the bonding state.

7. The insulation displacement unit according to claim 3, wherein the electric wire supporting plate and the base supporting plate are fixed to each other by a locking means in the bonding state.

8. The insulation displacement unit according to claim 4, wherein the electric wire supporting plate and the base supporting plate are fixed to each other by a locking means in the bonding state.
